(19) United States
(12) Patent Application Publication
(10) Pub. No.: US 2004/0240353 A1
(43) Pub. Date: Dec. 2, 2004

(54) Processing system having optical disk apparatus

(76) Inventor: Mitsuru Hasegawa, Hannou-shi (JP)

Correspondence Address: ANDERSON, KILL & OLICK, P.C., 1251 AVENUE OF THE AMERICAS, NEW YORK,, NY, 10020-1182, US

(21) Appl. No.: 10/855,214

(22) Filed: May 26, 2004

(30) Foreign Application Priority Data
May 26, 2003 (JP) 2003-147484

(51) Int. Cl. G11B 7/00

(52) U.S. Cl. 369/53.2; 369/53.25

(57) ABSTRACT

A system allowing a user to recognize that an optical disk apparatus is in a customized state. When an optical disk apparatus is customized by a user, system controller stores a customization parameter in a flash ROM. Upon receipt of an inquiry command at the time of activation of a host device, such as a PC, the system controller checks the content of the flash ROM and returns a command indicative of a customized state. Having received the command from the system controller, the PC displays any indication indicative of a customized state on a display device.

### BACKGROUND OF THE INVENTION

1. Field of the Invention

The present invention relates to a processing system having an optical disk apparatus, and in particular to a system having an optical disk apparatus adapted to user customization.

2. Description of the Related Art

Conventional computers, such as desk-top or lap-top computers, incorporate, or are connected to via an interface such as a USB, an optical disk apparatus for data recording and reproduction with respect to optical disks such as CDs, DVDs, and so forth. Upon activation, the computers recognize, through their BIOS, states of their peripheral devices including optical disk apparatuses or the like and display relevant information on their display devices.

Here, optical disk apparatuses with more sophisticated functions have recently become available, and users' demands on computers become more diversified, resulting in not a few users wishing, for example, for a reduction in rotation speed in data reproduction from DVD videos to thereby suppress wind-cutting noise. Such users customize their optical display devices to satisfy their demands.

Japanese Patent Laid-open Publication No. 2001-14055 describes technology in which a dip-switch adapted to a variety of settings is provided to an FDD and correlation between operation modes and the variety of settings of the dip-switch is recorded in an information data table, so that an operator can know a setting of the dip-switch by checking a monitor.

This prior art, however, only allows a user to confirm the setting of an FDD by looking at the monitor, and does not refer to cases of optical disk apparatuses. Moreover, as many of the optical disk apparatus do not include dip-switches, such an apparatus cannot use the information data table without any modification.

### SUMMARY OF THE INVENTION

The present invention can advantageously provide a processing system which allows a user to readily check the state of an optical disk apparatus, in particular, presence or absence of customization with the optical disk apparatus.

A system of the present invention comprises an optical disk apparatus; and a processing device connected to the disk apparatus, for sending an inquiry command to the optical disk apparatus, receiving a command sent from the optical disk apparatus in response to the inquiry command, the command indicating that the optical disk apparatus is in a customized state, and displaying on a display device an indication that the optical disk apparatus is in a customized state.

When the optical disk apparatus has been customized by a user, the optical disk apparatus returns a command indicating that the optical disk apparatus is in a customized state, in response to an inquiry command sent from the processing device. The processing device having received the command from the optical disk apparatus now knows that the optical disk apparatus is in a customized state, and displays any message on the display device, indicating that the optical disk apparatus is in a customized state.

In the above, the optical disk apparatus may have a non-volatile memory for storing a parameter associated with customization, access the non-volatile memory in response to the inquiry command received from the processing device, and, when a parameter different from a default value is stored in the non-volatile memory, send a command indicating that the optical disk apparatus is in a customized state.

According to the present invention, an optical disk apparatus may include a CD-ROM drive, a CD-R/RW drive, a DVD-ROM drive, a DVD-R/RW drive, a DVD-RAM drive, and so forth, while the processing device may include a personal computer.

The present invention will be more clearly understood from the following description of an embodiment of the present invention, though the embodiment does not limit the present invention in any way.

### BRIEF DESCRIPTION OF THE DRAWINGS

FIG. 1 is a diagram schematically showing a system structure of an embodiment of the present invention;

FIG. 2 is a diagram explaining a screen image to be displayed when an optical disk apparatus is not customized; and

FIG. 3 is a diagram explaining a screen image to be displayed when an optical disk apparatus is customized.

### DESCRIPTION OF THE PREFERRED EMBODIMENT

In the following, an embodiment of the present invention will be described based on the accompanying drawings, while referring to, as an example, a personal computer (PC) system having an optical disk apparatus 1.

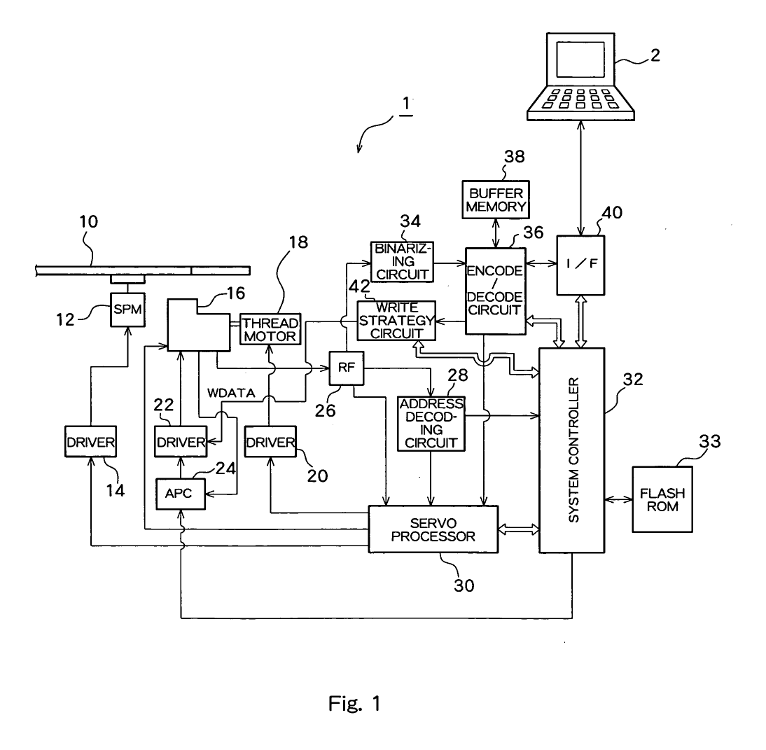

FIG. 1 is a diagram schematically showing an entire structure of a system in an embodiment of the present invention. The system comprises an optical disk apparatus 1 adapted to user customization and a PC 2 serving as a host device connected to the optical disk apparatus 1.

The optical disk apparatus 1 will first be described.

A CD, a DVD, or the like is mounted on a tray of an optical disk 10 and driven to rotate by a spindle motor SPM 12. The spindle motor SPM 12 is driven by a driver 14, which is subjected to servo control by a servo processor 30 so as to attain rotation at a desired speed. The optical disk 10 is loaded or unloaded with respect to the apparatus by a tray unload mechanism (not shown).

An optical pick-up 16 includes a laser diode (LD) for irradiating a laser beam to an optical disk 10 and a photo detector (PD) for receiving light reflected from the optical disk 10 and converting the received light into an electric signal. The optical pick-up 16 is positioned opposite to the optical disk 10 and is driven by a thread motor 18 so as to move in the radial direction of the optical disk 10. The thread motor 18 is driven by a driver 20, which is subjected to servo control by a servo processor 30, similar to the driver 14. The laser diode of the optical pick-up 16 is driven by a driver 22, which is controlled by an auto-power control circuit (APC) 24 such that a driving current becomes of a desired value. The APC 24 controls a driving current of the driver 22 so as to attain the optimized recording power as selected through OPC (Optimum Power Control) which is executed using a test area (PCA) of the optical disk 10. OPC is a process to be applied in order to determine a recording power which can attain desired signal quality. Specifically, in OPC, test data is recorded into a PCA of the optical disk 10 using recording power, while changing the recording power in a stepwise manner, and the recorded test data is then reproduced to evaluate the signal quality.

For reproduction of data recorded on the optical disk 10, laser light of reproduction power is emitted to the optical disk 10 from the LD of the optical pick-up 16 and light reflected from the optical disk 10 is received and converted by the photo detector (PC) into an electric signal to be output. A reproduction signal output from the optical pick-up 16 is supplied to an RF circuit 26, which then creates a focus error signal and a tracking error signal based on the received reproduced signal and supplies the resultant signals to the servo processor 30. Using the received error signals, the servo processor 30 applies servo control to the optical pick-up 16 to maintain the optical pick-up 16 in an on-focus state and an on-track state. The RF circuit 26 additionally supplies an address signal contained in the reproduced signal to an address decoding circuit 28. The address decoding circuit 28 demodulates the address signal to thereby restore data on an address on the optical disk 10 and supplies the obtained data to the servo processor 30 and the system controller 32.

The RF circuit 26 supplies a reproduced RF signal to a binarizing circuit 34, which binarizes the reproduced signal and supplies the obtained EFM signal (in the case of a CD disk) or an 8-16 modulation signal (in the case of a DVD disk) to an encode/decode circuit 36. The encode/decode circuit 36 applies either EFM demodulation or 8-16 demodulation and error correction to the binary signal to thereby obtain reproduced data and outputs the obtained reproduced data via an interface I/F 40 to a host device such as a personal computer. It should be noted that, before outputting the reproduced data to a host device, reproduced data is temporarily stored in a buffer memory 38 by the encode/decode circuit 36.

For recording data onto the optical disk 10, data to be recorded is supplied from the host device, and further to the encode/decode circuit 36 via the interface I/F 40. The encode/decode circuit 36 stores the data to be recorded in a buffer memory 38, and then encodes the data into EFM data or 8-16 modulated data to supply to a write strategy circuit 42. The write strategy circuit 42 converts the supplied EFM data into a multi-pulse (a pulse train) according to a predetermined recording strategy before supplying the resultant multi-pulse as recorded data to the driver 22. A recording strategy comprises, for example, pulse widths of a leading pulse and a trailing pulse and a pulse duty of a multi-pulse. The recording strategy is normally fixed at the optimum strategy as it affects recording quality. The recording strategy may be determined in OPC. Laser light with power modulated by recording data is emitted from the LD of the optical pick-up 16 to thereby record data onto the optical disk 10. After the data recording, the optical pick-up 16 emits laser light of reproduction power to reproduce recorded data, and supplies the obtained data to the RF circuit 26. The RF circuit 26 supplies the reproduced signal to the binarizing circuit 34, which then supplies binarized EFM data or 8-16 modulated data to the encode/decode circuit 36. The encode/decode circuit 36 decodes the EFM data or the 8-16 modulated data and verifies the data using the data recorded in the buffer memory 38. The result of verification is supplied to the system controller 32.

The system controller 32 is responsible for control over operation of the respective sections, as well as setting of a recording and reproduction mode, including a target rotation speed and a tray unload speed or the like, in the servo processor 30 according to the state of the interface I/F 40. The interface I/F 40 includes an eject key for unloading the tray and a pin for switching between master and slave modes. The system controller 32 determines, for example, whether or not the pin has been short-circuited by a user and, if it has, shifts to a state which allows customization. Thereafter, in response to a subsequent user's operation of an eject key, the system controller 32 sets a corresponding mode and stores a variety of relevant parameters in the flash ROM 33. It should be noted that, in this embodiment, a customized state refers to a state in which any parameters different from default parameters are set in the flash ROM 33. User customization may include the following.

(1) Reduction of Reproduction Speed.

The system controller 32 in a default state of the optical disk apparatus 1 drives the optical disk 10 at the highest rotation speed according to the type of an optical disk 10 mounted. With customization, the system controller 32 reduces the rotation speed for data reproduction.

(2) Reduction of Reproduction Speed with DVD Video

The system controller 32 reduces the rotation speed for data reproduction only when a DVD is mounted.

(3) Adjustment of Tray Unloading Speed.

The system controller 32 in a default state unloads a tray at a predetermined unloading speed. Upon customization, the system controller 32 reduces the tray unloading speed when any optical disk 10 other than a reference disk (12 cm disk) is mounted, so that discharging from the tray is prevented.

Upon activation of the PC 2, the PC 2 sends an inquiry command (for example, an “identify device” command) to the system controller 32 of the optical disk apparatus 1. The system controller 32 having received the inquiry command accesses the flash ROM 33 to determine whether or not any parameter different from a default parameter is set. When any parameter associated with a previously set mode is set in the flash ROM 33, which is therefore in a customized state, the system controller 32 returns a command indicating that the flash ROM 33 is in a customized state, in addition to its own ID or the like. Having received the response from the system controller 32, the PC 2 displays the received command on the display device.

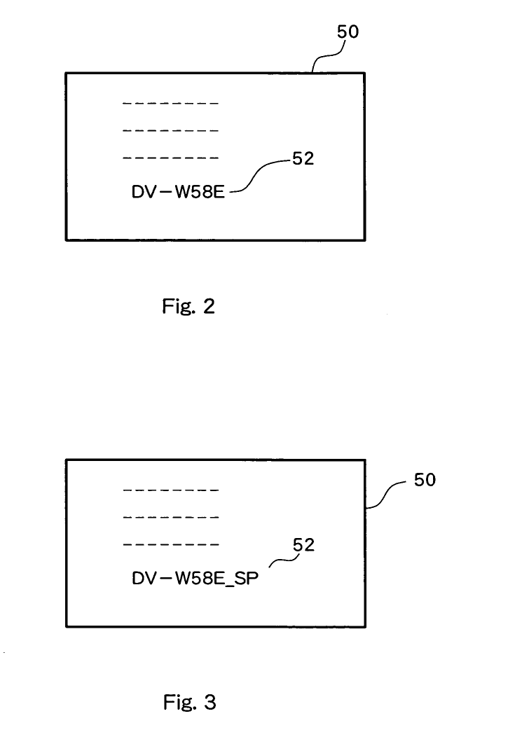

FIGS. 2 and 3 show examples of a screen image to be shown on a display device at the time of activation of the PC 2. FIG. 2 shows an example of a screen image to be displayed when the optical disk apparatus 1 is not customized, where a text “DV-W58E” or the like is shown in association with the optical disk 10, in addition to a CPU type, memory capacity, and any other information.

FIG. 3 shows an example of a screen image to be displayed when the optical disk apparatus 1 is customized, where a text “DV-W58E SP” is shown in association with the optical disk 10, in addition to a CPU type, memory capacity, and any other information. “_SP” indicates an optical disk apparatus 1 in a customized state. By viewing this indication, the user can easily know that the optical disk 10 connected to the PC 2 is in a customized state.

In this embodiment, the flash ROM 33 checks the content of the flash ROM 33 to determine whether or not the optical disk 10 is in a customized state. When the optical disk apparatus 1 is in a customized state, any commands describing details of the customization may additionally be returned to the PC 2 based on the parameters set, so that the PC 2 can display any indications including marks, numbers, and so forth, which describe the content of the customization, with some examples of the indications being shown below.

“DV-W58E_{—}01” (reduction of a reproduction speed for a DVD)

“DV-W58E_{—}02” (adjustment of a tray unloading speed)

“DV-W58E_{—}03” (reduction of a recording speed)

As described above, in this embodiment, parameters associated with customization are stored in the flash ROM 33, and, in response to an inquiry command from the PC 2, any commands according to the content of the flash ROM 33 are returned to the PC 2. Then, the PC 2 having received the reply displays any message indicative of the optical disk apparatus 1 in a customized state on a display device.

It should be noted that, although it is described in the above that customization is attained by short-circuiting a pin for switching between master and slave modes and operating an injection key, customization is not limited to the above-described manner but may be realized in any other manner.

Further, although a message indicative of an optical disk 10 in a customized state appears on a display device at the time of activation of the PC 2 in the above, the message may be shown at any timing other than activation of the PC 2. For example, an icon concerning the optical disk apparatus 1 may be shown after activation of the PC 2, and in that case, the message maybe shown at a predetermined location, for example, at a lower right corner on the screen in the form of different icons depending on a default or customized state. For example, the icon may be shown reversed in a customized state, and a portion corresponding to a tray in the icon maybe shown emphasized when a tray unloading speed has been customized.

What is claimed is:

1. A processing system having an optical disk apparatus, comprising:
an optical disk apparatus; and
a processing device connected to the disk apparatus, for sending an inquiry command to the optical disk apparatus, receiving a command sent from the optical disk apparatus in response to the inquiry command, the command indicating that the optical disk apparatus is in a customized state, and displaying on a display device, an indication telling that the optical disk apparatus is in a customized state.

2. The processing system according to claim 1, wherein the optical disk apparatus has a non-volatile memory for storing a parameter associated with customization, accesses the non-volatile memory in response to the inquiry command sent from the processing device, and, when a parameter different from a default value is stored in the non-volatile memory, sends a command indicating that the optical disk apparatus is in a customized state.

3. The processing system according to claim 2, wherein the optical disk apparatus sends a command describing content of customization, together with the command indicating that the optical disk apparatus is in a customized state.

4. The processing system according to claim 3, wherein the content of customization relates to a reproduction speed of an optical disk.

5. The processing system according to claim 3, wherein the content of customization relates to a tray unloading speed.

6. The processing system according to claim 3, wherein the content of customization relates to a recording speed of an optical disk.

7. A processing system, comprising:
an optical disk apparatus; and
a computer connected to the optical disk apparatus,
wherein
the optical disk apparatus includes
a rewritable ROM for storing a customization parameter, and
a controller for accessing the ROM in response to an inquiry from the computer and, when a customization parameter different from a default state is stored in the ROM, returning a command indicative of a customized state, and
the computer has a display device for displaying the command received from the controller.
